(19) United States
(12) Patent Application Publication
(10) Pub. No.: US 2018/0125027 A1
(43) Pub. Date: May 10, 2018

(54) Aesthetically Improved Animal Waste Collection Pads

(71) Applicant: Aimee LaNieve Spiers, Green Brook, NJ (US)

(72) Inventor: Aimee LaNieve Spiers, Green Brook, NJ (US)

(21) Appl. No.: 14/247,242

(22) Filed: Apr. 7, 2014

(51) Int. Cl. A01K 1/015; A01K 1/01; B32B 7/12; B32B 7/06; B32B 5/02; B32B 27/32; B32B 27/36

(52) U.S. Cl. CPC A01K 1/0157; A01K 1/0107; B32B 7/12; B32B 2471/04; B32B 5/022; B32B 27/32; B32B 27/36; B32B 7/06

(57) ABSTRACT

A pet waste collection pad with a decorative or camouflaged picture on the upward facing permeable surface is described which provides an aesthetically pleasing alternative to pet owners.

### DESCRIPTION OF INVENTION

What is claimed as new and desired to be protected is a multifunctional, disposable waste collection pad, particularly useful for owners of domestic animals such as dogs, having a first top layer or layers made of a permeable material that has a wicking action, the top layer or layers have been decoratively printed and/or dyed with an aesthetic, decorative, and/or camouflaged pattern, design, and/or photograph, a second absorbent layer(s) which may consist of tissue paper and/or absorbent pulp or other absorbing material, and a third substantially impermeable bottom backing layer preferably a Polyethylene film (PE). The top sheet(s) is preferably a printed non-woven layer(s) having an improved surface appearance both before and after the pads have been soiled and therefore making the pads more appealing or desirable to use. These decorative pads will also provide an improved appearance and a stylish alternative to the existing disposable waste pads currently available at stores such as Petco, Petsmart, Walmart, Kmart, Target, grocery stores, and other pet supply stores.

The invention is illustrated in the figures which are briefly described as follows:

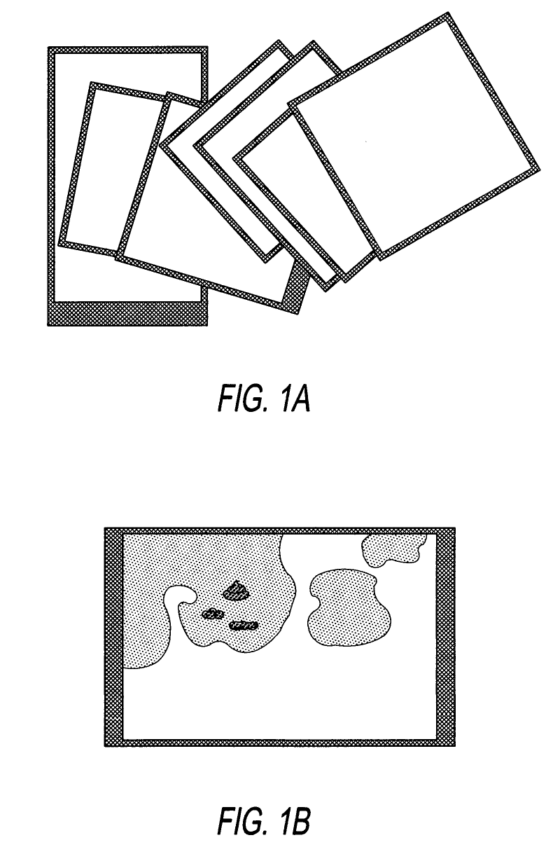

FIG. 1A is a view of the disposable waste pad available today.

FIG. 1B is the present pad after use.

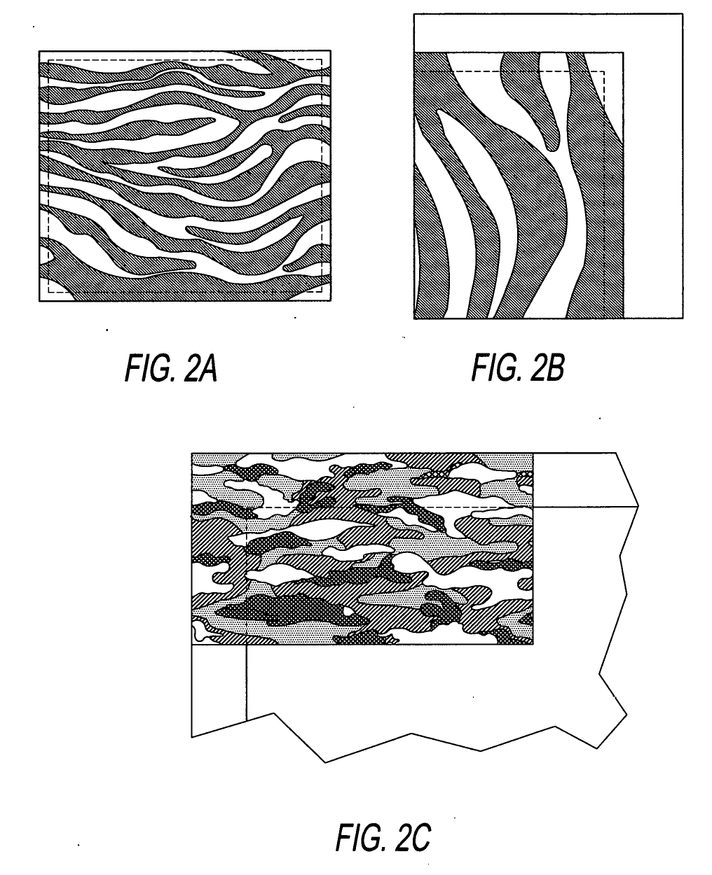

FIG. 2A shows a pad of this invention with a zebra print pattern.

FIG. 2B is a close-up photo of the same pad.

FIG. 2C shows a camouflage print on a scrim which can be bonded to a pad to form the top of the pad.

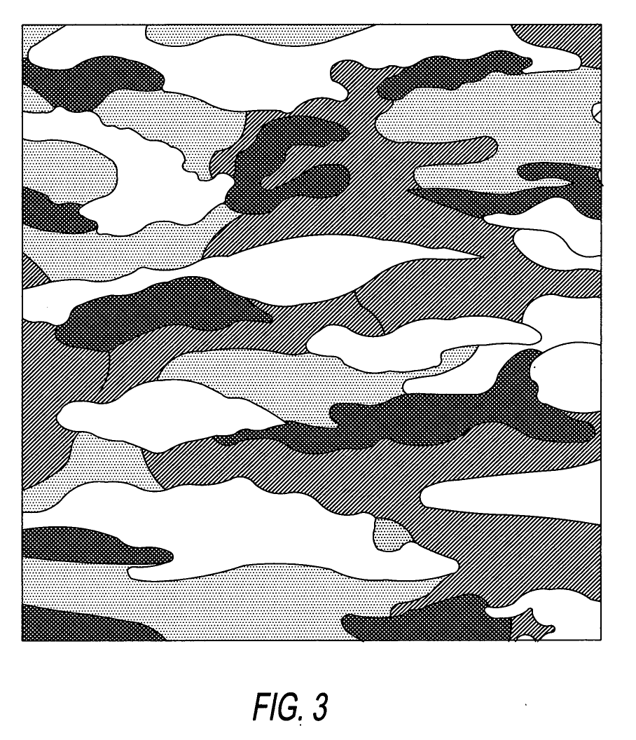

FIG. 3 is a pad covered with camouflage scrim of this invention.

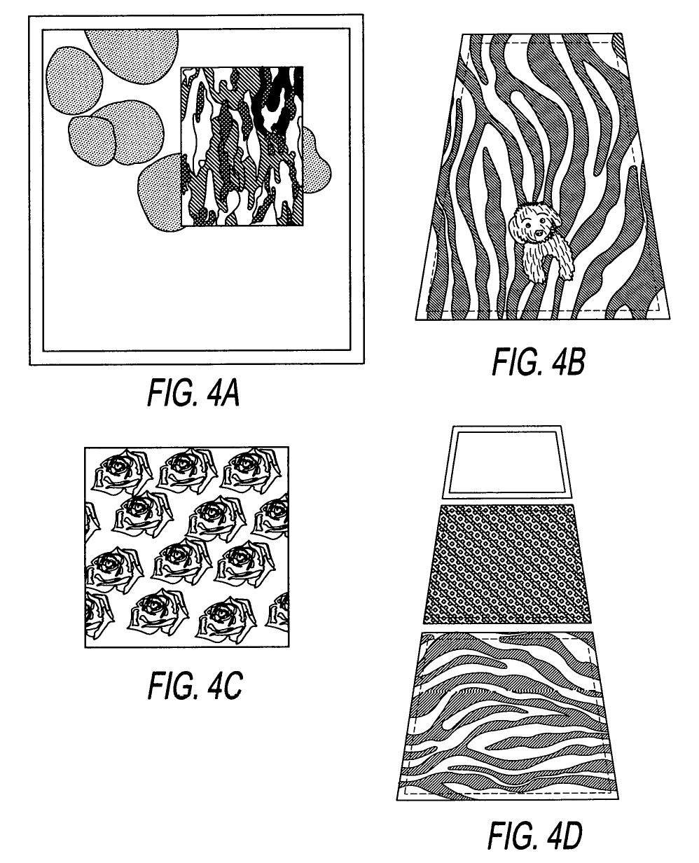

FIG. 4A shows a soiled conventional pad with a camouflage pattern overlay which hides the soiling.

FIG. 4B shows the pleasing zebra pattern pad with a dog.

FIG. 4C is a rose pattern printed pad of this invention.

FIG. 4D shows from the top a conventional pad, a blue carpet pattern print pad of the invention and the zebra print pad.

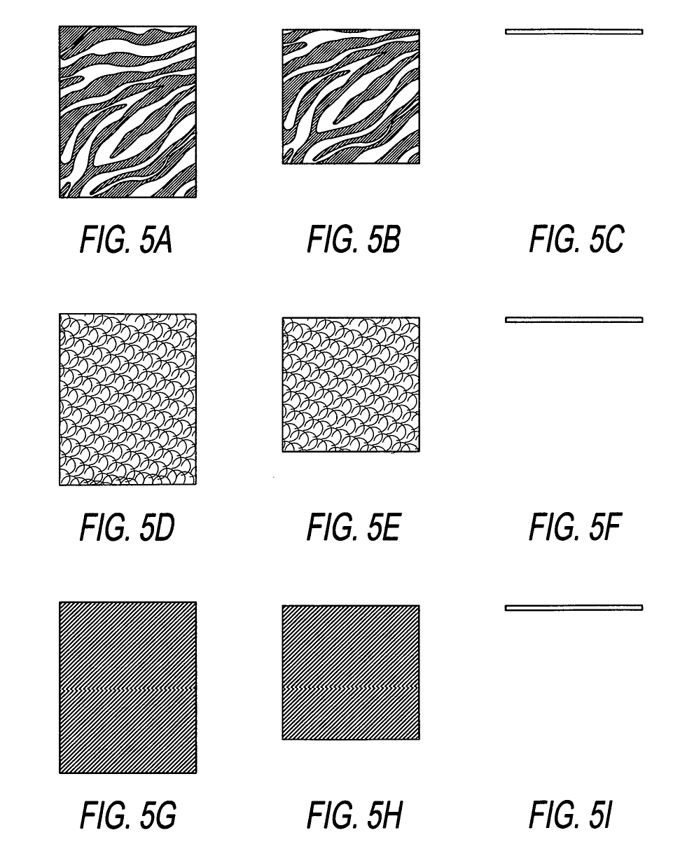

FIG. 5A, FIG. 5B, FIG. 5C, FIG. 5D, FIG. 5E, FIG. 5F, FIG. 5G, FIG. 5H, and FIG. 5I show the construction of a pad of this invention where FIG. 5A, FIG. 5B and FIG. 5C are the surface layer demonstrating two different sizes and the thickness respectively. FIG. 5D, FIG. 5E and FIG. 5F represent the middle absorbent layer which may consist of pulp FIG. 5D, tissue paper FIG. 5E or other absorbent materials. FIG. 5F shows the thickness. The bottom backing layer provides a waterproof barrier and is preferably polyethylene film. FIG. 5G and FIG. 5H show the backing for the two sizes and FIG. 5I the thickness.

The present invention relates to altering and specifying the top layer(s) of a disposable animal waste pad creating an improved product. This new article will be such that when it is used and therefore viewed on the floor, bed, or elsewhere when traveling, it has an improved appearance both before and after being soiled and is therefore more appealing and desirable to use (see FIG. 2A, FIG. 2B, FIG. 2C and FIG. 4A).

Due to the irregular, inconsistent and transparent nature of the top layer non-woven material typically used in the waste pads available today, usually a very lightweight, sparse material from 8 to 10 grams per square meter (GSM) spunbond polypropylene (PP), see FIG. 1A, it is preferable that the top layer of the current invention consist of a more uniform, less transparent non-woven material, preferably a 14 to 85 GSM polyester non-woven material or polypropylene (PP) spunbond in order to obtain a more desirable, consistent pattern or color, with consistent depth of color when printed while still being hydrophilic with a wicking action; this top surface material may alternatively be a 14 to 85 GSM colored material, for example, a red 49 GSM spunbond PP that is or is not printed.

Preferably, the top surface material is printed with a pattern, décor, high or low resolution photograph, or picture using one, two, or multi-color printing prior to the pad's assembly. The printed top surface material(s) is preferably a non-woven material, for example, an 8 to 150 GSM polyester flat bond or spunbonded PP, a spunbond/meltblown/spunbond (SMS) tri-laminate, a spunbond made via Reico IV process technology, a polyester spunbond, a nonwoven meltblown, spunlace, or airlaid, or a polyethylene (PE) film permeated with microholes, or a 3-D aperture film, it may instead be composed of a Biodegradable polyester (such as a PLA), viscose, tencel, or cotton, or a combination of two or more materials.

This innovation will also include a new manufacturing process and machine for mass production and custom designed animal waste pads. This innovation will describe a new machine appropriate for mass production, capable of combining both the assembly process of the pads and the printing process of the pads: 1. The printing process may occur before or after the assembly process, 2. The printing process may occur either on the final assembled pad or on material(s) prior to assembly of the waste pads, 3. The printing process may be a digital printing process and/or a non-digital printing process.

The machine currently capable of manufacturing a basic disposable waste pad for mass production combines and layers the materials, blows in the absorbent pulp, glues the edges of the pads, hot presses the pads adding a quilted effect if desired, cuts the pads, folds the pads, and packages the pads. The current innovation will be specified in a utility patent to be filled and will be capable of combining both the manufacturing process and the printing process in one machine to efficiently manufacture and print the disposable waste pads for mass production. The printing process(es) will be specified in the utility patent and may include digital printing, standard flexographic (ink) or serigraphic (coloured paste) methods, inkjet printing, rotor gravure printing, videojet printing (binary array printing), screen printing or another method to be determined and preferably using solvents that are safe and eco-friendly.

Currently the top surface layer non-woven material has to be shipped to the printing factory, then shipped to the waste pad manufacturing facility, then shipped to the distributor; for a disposable product, these shipping costs are inefficient; the current innovation will provide a more efficient machine and manufacture process for mass producing the animal waste collection pads with printed top surface layer(s). The technical problem at the heart of the invention is that of providing equipment capable of decoratively printing, assembling and packaging disposable waste pads as to allow the achievement of an economically advantageous production process and a final product which is colorfast, will not rub off, and is kind to the environment.

The waste pad consists of a permeable top surface layer(s), as described above, an absorbent layer or layers based on light, medium, strong, or maximum absorbency, and an impermeable bottom waterproof backing layer. For pets, the pads may be treated with an attractant and for odor control. The waste pads will be available in various sizes and absorbency levels.

Specifications will be detailed regarding the preferred method(s) for printing and manufacturing two or more types of decorative waste collection pads for production and mass production.

One such pad, as described above, has a top layer anywhere from 14 to 120 GSM which has been decoratively printed and/or dyed before it is fed into the waste pad assembly machine (which preferably layers the materials, blows in the absorbent pulp, glues, cuts, folds, and packages the designer waste pads.) The higher the grams per square meter and per inch consistency of the nonwoven material (while still maintaining acceptable water pass-through or wicking ability), the less transparent the material, and the greater the printed image quality and concentration and depth of color, thereby creating a richer, nicer looking end printed product or colored product.

The second type of decorative waste pad will be printed on the top surface (and/or dyed) after the pad has been layered and assembled therefore allowing the ink or dye and the design or image to penetrate through to all of the layers thereby creating a deeper concentration of color and richness to the image while maintaining desired absorbency, water pass-through, steadfastness of color, water and light fastness, as well as good rubbing and scratching fastness or tensile strength. It is important that the color of the dye or ink does not rub off onto the paws of an animal or if used by people, onto the skin of the person or baby using the waste pad.

An additional product innovation is a top scrim that, as described for the top surface layer above, is printed or colored and sold separately to be applied to the top layer of any common animal waste pad. This innovation is a printed or colored scrim to lay over any commercial waste pad. The backing would have an ability to stick or adhere to the commercial disposable waste pad using a peel off double sided tape, a weak glue like on a Post-it or a static charge that would hold it to the pad. This option would therefore be a decorative top layer that would likely not have a waterproof backing. The intent of this product would be to apply it to a pre-existing non-decorated disposable waste pad. For example, this article could be packaged separately and sold to be laid on top of any of the waste pads shown in FIG. 1A.

A waste pad provides an area for a dog or other animal to relieve itself without damaging flooring and makes cleanup of the area easier because they absorb liquid waste and are, in general, disposable. These pads are useful for the housebreaking process of puppies as well as for dogs that are left in the home for prolonged periods of time. Animal waste pads offer more freedom and an easier life style for pet owners. No longer do you have to rush home to let the dog out or if the weather is bad, owners just use a waste pad. Great for older pets that have a problem with bladder control.

Waste pads are often left on the floor for the pet to use. Providing the pads in a predetermined area provides consistency to the animal using the pads and helps reinforce the use of the pad in a specific area. Currently, the pads in existence are medicinal in appearance, most commonly having a white surface, absorbent layers, and a blue waterproof backing, one popular brand for dogs is “Wee-Wee Pads” by Four Paws Products, Ltd.

The existing pads on the market are not stylish or aesthetically pleasing in any way and are very unpleasant to look at both before and after being soiled by a pet. They stand out against the flooring and even amplify the unattractive, unappealing view of the waste pads in a room. People having a preference for a coordinated, nicely decorated home may particularly appreciate having nicely decorated waste pads that coordinate with their floors, fabrics, room colors, pet's names, or their personal style.

Currently, the majority of the disposable waste pads are manufactured using a spun-bonded non-woven fabric for the top surface layer. This spun-bonded non-woven fabric is a practical top layer, especially for use as a bed pad for people, adults and children, because it has wicking or water pass through ability, is soft, stretchable, hard to tear, strong, and economical. The waste pads currently on the market all generally consist of a white or off white top layer which is highly transparent. It is easy to see through this top spun-bonded layer to all the underlying layers: the white tissue paper layers, the blown in absorbent pulp (which typically looks like sporadic white dots), the blue, green, tan, or white PE waterproof backing around the edges of the waste pad, giving the pad a very medical, utilitarian appearance, see FIG. 1A.

The challenge of the current invention was to invent a product that is more specifically suitable for owners of domestic dogs, caring for the waste needs of domestic dogs, while at the same time caring for the interior decorating and aesthetic preferences of their owners, providing a useful decorative disposable waste pad that is more desirable to use than the medical, utilitarian waste pads available today.

This invention will provide an improved appearance for users of disposable waste pads and can also offer prints, photographs, colors, patterns, and/or designs that are novelty, humorous, and/or uplifting. Some examples of stylish and/or camouflaged prints and/or photographs for the pads would include: hardwood floor patterns or medallions or parquet floors, several standard carpet patterns and colors, shag rug, ceramic or other tile patterns, various marble or granite patterns, oriental rug patterns, ornate needlepoint pillow designs with varied fringes, various colored zebra patterns, cheetah or other animal skin or fur patterns, snake skin patterns, fur or faux fur, flowers, roses or a bed of roses, grass with flowers, a grassy patch, a patch of clover, moss covered stones, pebbles, seasonal colorful leaves and acorns, tree bark, bamboo, various leafs, various photographs or drawings of butterflies, various toile patterns and colors, lattice patterns, roses or other flowers on lattice, trompe l'oeil designs, plaids, tie dye, colorful hearts and peace signs, favorite or opposing sports teams or rivals which may or may not require licensing, for example, teams in the NBA, NFL, AFL, MLB, NHL, MLS professional soccer leagues and associations, college and university teams, nostalgic or chic newspaper prints from New York Times, London, Paris, etc., nostalgic or chic magazine covers, Marilyn Monroe or other sex symbols, famous works of art such as Monet's “Water Lillies” for example, various designs from Disney, Burberry patterns, Ralph Lauren patterns or other designers and brands such as Betsey Johnson, Juicy Couture, Justice, Coach, or Chanel, patterns from fabric and carpeting companies such as Scalamandre or Karistan, popular or custom puppy names or monograms, customized pads, trendy styles, patterns and colors, political candidates or opponents, customers own photographs of their flooring to provide customized camouflaging, customers own photographs of their choosing to accommodate their preferences. The current invention and designs may be used for animal waste pads or for human bed pads or baby changing pads or travel pads.

This patent is developed with people, pets, and owners in mind. Thoughtful details for colorful, elegant, cheerful, humorous and/or playful designs for use in your home, when travelling, or for patients in hospitals make taking care of animals or people easier, more enjoyable, and more fun, resulting in happier, healthier pets, babies, and people. Beautifully designed disposable waste pads will provide an improved appearance, a stylish, coordinated home, and a more enjoyable, easier caretaking experience resulting in happier, healthier pets and people.

Example 1 The zebra stripe of FIG. 2A and FIG. 2B was printed directly onto a conventional pet waste collection pad by large format, ink-jet printer.

Example 2 The camouflage top layer of FIG. 2C and FIG. 3, a 100% polyester flat bond nonwoven fabric of 34 GSM was printed with a camouflage pattern by a screen printing process. With light spray application of glue on the downward facing side, this fabric makes a more aesthetically pleasing cover for waste collection pads.

What is claimed is:

1. A pet waste collection pad with a decorative or camouflaged picture on the upward facing permeable surface. The picture may be applied by digital or conventional printing processes to the surface of the finished pad or to the top layer or layers of the pad before or during the pad assembly process.

2. A pet waste collection pad with a decorative or camouflaged picture on the upward facing permeable surface preferably where the surface is a nonwoven fabric of density from 14 to 85 GSM, denser than the conventional top layer to permit a brighter, higher quality picture to be printed.

3. A permeable fabric with a decorative or camouflaged picture to be placed on top of a conventional pet waste collection pad and attached to the pad by any of several methods including a weak glue coating, double sided tape or a static charge on the downward facing side of the fabric. The preferred top fabric is a nonwoven polypropylene or polyester of 14 to 85 GSM, denser than the top fabric of the conventional pads.
